(19) United States
(12) Patent Application Publication
(10) Pub. No.: US 2006/0034374 A1
(43) Pub. Date: Feb. 16, 2006

(54) Method and device for motion estimation and compensation for panorama image

(76) Inventors: Gwang-Hoon Park, Seongnam-si (KR); Sung-ho Son, Gwangmyeong-si (KR)

Correspondence Address: Stanzione & Kim, LLP, 1740 N St., NW, 1st Fl., Washington, DC, 20036, US

(21) Appl. No.: 11/201,153

(22) Filed: Aug. 11, 2005

Related U.S. Application Data
(60) Provisional application No. 60/601,137, filed on Aug. 13, 2004.

(30) Foreign Application Priority Data
Oct. 12, 2004 (KR) 2004-81353

(51) Int. Cl. H04N 11/02; H04N 7/00; H04N 7/12; H04B 1/66; H04N 11/04

(52) U.S. Cl. 375/240.16; 348/36

(57) ABSTRACT

A device and a method for motion estimation and compensation to be performed on a panorama image with a 360° omni-directional view based on that a spatial relation between left and right borders of the panorama image is very high. Accordingly, it is possible to improve an image quality through effective and precise estimation and compensation for the motion of the panorama image. In particular, it is possible to improve the image quality at the right and left edges of the panorama image.

### CROSS-REFERENCE TO RELATED APPLICATIONS

This application claims the priority of U.S. Provisional Patent Application No. 60/601,137, filed on Aug. 13, 2004, in the U.S. Patent & Trademark Office and Korean Patent Application No. 2004-81353, filed on Oct. 12, 2004, in the Korean Intellectual Property Office, the disclosures of which are incorporated herein in their entirety by reference.

### BACKGROUND OF THE INVENTION

1. Field of the Invention

The present general inventive concept relates to motion estimation and compensation for a panorama image, and more particularly, to a method and apparatus to estimate a motion of a panorama image containing 360° omni-directional image information, and a method and apparatus to compensate for the motion of the panorama image.

2. Description of the Related Art

An omni-directional video camera system is capable of acquiring a 360° omni-directional view from a single viewpoint. The omni-directional video camera system includes a camera to which a special mirror, such as a hyperboloid mirror, or a special lens, such as a fish-eye lens, is installed, or a plurality of cameras.

Three-dimensional (3D) realistic broadcasting may be applied to omni-directional video coding. As an example of a 3D realistic broadcasting service, a viewer's terminal receives all image information regarding scenes viewed from diverse viewpoints, such as the viewpoints of a pitcher, a catcher, a hitter, and an audience on a first base side in a baseball game, and the viewer can select a desired viewpoint to view one of the scenes from the desired viewpoint.

An image captured by the omni-directional camera system has characteristics corresponding to a 3D cylindrical environment and thus is transformed into a two-dimensional (2D) plane image. In this case, the 2D plane image is a panorama image with a 360° omni-directional view, and omni-directional video coding is performed on the 2D panorama image.

In a motion estimation technique, which is one of image coding techniques, a motion vector is computed by detecting a data unit, which is most similar to a data unit in a current frame, from a previous frame using a predetermined evaluation function, the motion vector represents a position difference between the data units, and, in general, 16×16 macro blocks are used as the data blocks but the sizes of macro blocks are not limited, and for instance, the data units may be 16×8, 8×16, or 8×8 macro blocks.

A conventional motion estimation technique performed in units of 1 6×16 macro blocks will now be described in greater detail. First, a motion vector of a current macro block of a current frame is predicted using a plurality of previous macro blocks of a previous frame adjacent to a position corresponding to the current macro block of the current frame. FIG. 1 illustrates a plurality of previous macro blocks A, B, C, and D of the previous frame used to estimate the motion vector of a current macro block X of the current frame. The previous macro blocks A through D are encoded before coding of the current macro block X.

However, sometimes, some of previous macro blocks adjacent to the current macro block X are unavailable in estimating the motion vector of the current macro block X according to the position of the current macro block X in the current frame. FIG. 2A illustrates a case where the previous macro blocks B, C, and D required for estimation of the motion vector of the current macro block X are not present. In this case, the motion vector of the current macro block X is set to 0.

FIG. 2B illustrates a case where the previous macro blocks A and D are not present. In this case, the motion vectors of the previous macro blocks A and D are set to 0, and the motion vector of the current macro block X is set to a median value of the motion vectors of the previous macro blocks A through D.

FIG. 2C illustrates a case where the previous macro block C is not present. In this case, the motion vector of the previous macro block C is set to 0, and the motion vector of the current macro block X is set to the median value of the motion vectors of the previous macro blocks A through D.

After predicting the motion vector of the current macro block X, the similarity between each reference macro block in a reference frame indicated by the predicted motion vector and the current macro block X is computed using a predetermined evaluation function. Next, a reference macro block that is most similar to the current macro block X is detected from the reference frame within a predetermined search range. In general, a sum of absolute differences (SAD) function, a sum of absolute transformed differences (SATD) function, or a sum of squared differences (SSD) function is used as the predetermined evaluation function.

During detection of the most similar reference macro block within the predetermined search range, some or all pixels of the reference macro blocks may be present outside the predetermined search range. In this case, as illustrated in FIG. 3, it is necessary to pad values of the pixels on left and right borders of the most similar reference macro block pixels to an outside of the left and right borders, respectively, to perform motion estimation and compensation. This motion estimation and compensation is referred to as motion estimation and compensation in an unrestricted motion vector (UMV) mode.

FIG. 4A illustrates a cylindrical image with a 360° omni-directional view. FIG. 4B illustrates a panorama image with a 360° omni-directional view, taken along with a line X of the cylindrical image of FIG. 4A. Referring to FIG. 4B, a left side A and a right side B of a human-shaped object shown in FIG. 4A are positioned at the right and left borders of the panorama image, respectively. That is, a spatial relation between the right and left borders of the panorama image with the 360° omni-directional view is very high.

Thus, it is ineffective to perform the conventional motion estimation and compensation on a panorama image with an omni-directional view without considering characteristics of the panorama image. Thus, a method of effectively estimating and compensating for the motion of a panorama image with an omni-directional view is required.

### SUMMARY OF THE INVENTION

The present general inventive concept provides a method and apparatus to effectively and precisely estimate a motion of a panorama image containing omni-directional image information.

The present general inventive concept also provides a method and apparatus to effectively and precisely compensate for a motion of a panorama image containing omni-directional image information.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of estimating a motion of a current panorama image containing 360° omni-directional view information, the method comprising estimating a motion vector of a current data unit of the panorama image using motion vectors of a plurality of previous reference data units of a reference image adjacent to the current data unit, when one or more pixels of one of the reference data units indicated by the estimated motion vector are present outside one of left and right borders of a reference image, padding an image in a predetermined range from the other border of the reference image outside the one of the left and right borders; obtaining values of all pixels of the reference data unit from the padded reference image; and determining a similarity between the current data unit and the reference data unit using a predetermined evaluation function.

The foregoing and/or other aspects of the present general inventive concept may also be achieved by providing a method of estimating a motion of a current panorama image containing 360° omni-directional view information, the method comprising estimating a motion vector of a current data unit of the panorama image using motion vectors of a plurality of previous reference data units adjacent to the current data unit, when one or more pixels of one of reference data unit indicated by the estimated motion vector are present outside one of left and right borders of the reference image, obtaining values of all pixels of the one of the reference data units of the reference image from a cylindrical image which is obtained by connecting the left and right borders of the reference image when the reference image is the cylindrical image, and determining a similarity between the current data unit and the reference data unit using a predetermined evaluation function.

The foregoing and/or other aspects of the present general inventive concept may also be achieved by providing an apparatus to compensate for a motion of a panorama image containing 360° omni-directional view information, the apparatus comprising a memory to store a reference image to be used for motion estimation of the panorama image, and motion vectors of a plurality of previous reference data units adjacent to a current data unit of the panorama image, and a motion estimating unit to estimate a motion vector of the current data unit using the motion vectors of the plurality of the previous data units, when one or more pixels of one of the reference data units indicated by the estimated motion vector are present outside one of left and right borders of the reference image, padding an image in a predetermined range from the other border of the reference image outside the one of the left and right borders, to obtain values of all pixels of the reference data unit from the padded reference image, and to determine a similarity between the current data unit and the reference data unit using a predetermined evaluation function.

The foregoing and/or other aspects of the present general inventive concept may also be achieved by providing an apparatus to estimate a motion of a panorama image containing 360° omni-directional view information, the apparatus comprising a memory to store a reference image to be used for motion estimation of the panorama image, and motion vectors of a plurality of previous reference data units of the reference image adjacent to a current data unit of the panorama image, and a motion estimating unit to estimate a motion vector of the current data unit using the motion vectors of the plurality of the previous data units, when one or more pixels of one of the reference data units indicated by the estimated motion vector are present outside one of left and right borders of the reference image, to obtain values of all pixels of the reference data unit from a cylindrical image obtained by connecting the left and right borders of the reference image on an assumption that the reference image is the cylindrical image, and to determine a similarity between the current data unit and the reference data unit using a predetermined evaluation function.

The foregoing and/or other aspects of the present general inventive concept may also be achieved by providing a method of compensating for a motion of a panorama image containing 360° omni-directional view information, the method comprising receiving a motion vector of a current data unit of the panorama image, when one or more pixels of one of reference data units of a reference image indicated by the motion vector of the current data unit are present outside one of left and right borders of the reference image, padding the reference image in a predetermined range from the other border of the reference image outside the one of the left and right borders of the reference image, obtaining values of all pixels of the reference data unit from the padded reference image, and reproducing the current data unit using the values of the pixels of the reference data unit.

The foregoing and/or other aspects of the present general inventive concept may also be achieved by providing a method of compensating for a motion of a panorama image containing 360° omni-directional view information, the method comprising receiving a motion vector of a current data unit of the panorama image, when one or more pixels of one of reference data units of a reference image indicated by the motion vector of the current data unit are present outside one of left and right borders of the reference image, obtaining values of all pixels of the reference data unit from a cylindrical image which is obtained by connecting the left and right borders of the reference image when the reference image is the cylindrical image; and reproducing the current data unit using the values of the pixels of the reference data unit.

The foregoing and/or other aspects of the present general inventive concept may also be achieved by providing an apparatus to compensate for a motion of a panorama image containing 360° omni-directional view information, the apparatus comprising a memory to store a reference image to be used for motion estimation of the panorama image, and a motion compensating unit to receive a motion vector of a current data unit of the panorama image, when one or more pixels of one of reference data units of a reference image indicated by the motion vector of the current data unit are present outside one of left and right borders of the reference image, to pad the reference image in a predetermined range from the other border of the reference image outside the one of the left and right borders of the reference image, to obtain values of all pixels of the reference data unit from the padded reference image, and to reproduce the current data unit using the values of the pixels of the reference data unit.

The foregoing and/or other aspects of the present general inventive concept may also be achieved by providing an apparatus to compensate for the motion of a panorama image containing 360° omni-directional view information, the apparatus comprising a memory to store a reference image to be used for motion estimation of the panorama image; and a motion compensating unit to receive a motion vector of a current data unit of the panorama image, when one or more pixels of reference data units of a reference image indicated by the motion vector of the current data unit are present outside one of left and right borders of the reference image, to obtain values of all pixels of the reference data unit from a cylindrical image which is obtained by connecting the left and rights borders of the reference image when the reference image is the cylindrical image; and reproducing the current data unit using the values of the pixels of the reference data unit.

The foregoing and/or other aspects of the present general inventive concept may also be achieved by providing an apparatus to estimate a motion vector of a panorama image containing 360° omni-directional view information, the apparatus comprising a memory to store a reference image having first and second borders and first and second reference data units disposed adjacent to the first border and the second border, respectively, within the reference image, and a motion estimating unit to receive a current data unit of a current image and the reference data units of the reference image from the memory, and to estimate a motion vector of the current data unit using one of the first and second reference data units of the reference image which is not included in a search area when the other one of the first and second reference data units is included in the search area.

The foregoing and/or other aspects of the present general inventive concept may also be achieved by providing an apparatus to generate a panorama image containing 360° omni-directional view information, the apparatus comprising a decoding unit to decode a bitstream having data corresponding to a current image and a reference image, and to generate a motion vector of a current data unit of the current image to correspond to a search area of the reference image which includes a first reference data unit disposed on a first border of the reference image, a panorama image motion compensating unit to generate a reference macro block of the first reference data unit of the reference image using a second reference data unit disposed on a second border of the reference image which is not included in the search area according to the motion vector, and an output unit to generate the current image according to the reference macro block and data corresponding to the decoded bitstream.

The foregoing and/or other aspects of the present general inventive concept may also be achieved by providing an apparatus having an encoder and a decoder to estimate a motion vector of a panorama image containing 360° omni-directional view information. The encoder comprises a memory to store a reference image having first and second borders and first and second reference data units disposed adjacent to the first border and the second border, respectively, within the reference image, a motion estimating unit to receive a current data unit of a current image and the reference data units of the reference image from the memory, and to estimate a motion vector of the current data unit using one of the first and second reference data units of the reference image which is not included in a search area when the other one of the first and second reference data units is included in the search area, a panorama image motion compensating unit to generate a reference macro block according to the motion vector and the reference image, and a coding unit to generate an bitstream according to the current image and the reference macro block. The decoder comprises a decoding unit to decode the bitstream having data corresponding to the current image and the reference image, and to generate the motion vector of the current data unit of the current image to correspond to the search area of the reference image which includes the first reference data unit disposed on the first border of the reference image, a second panorama image motion compensating unit to generate the reference macro block of the first reference data unit of the reference image using the second reference data unit disposed on the second border of the reference image which is not included in the search area according to the motion vector, and an output unit to generate the current image according to the reference macro block and data corresponding to the decoded bitstream.

The foregoing and/or other aspects of the present general inventive concept may also be achieved by providing a method of estimating a motion vector of a panorama image containing 360° omni-directional view information, the method comprising storing a reference image having first and second borders and first and second reference data units disposed adjacent to the first border and the second border, respectively, within the reference image, and receiving a current data unit of a current image and the reference data units of the reference image from the memory, and estimating a motion vector of the current data unit using one of the first and second reference data units of the reference image which is not included in a search area when the other one of the first and second reference data units is included in the search area.

The foregoing and/or other aspects of the present general inventive concept may also be achieved by providing a method of generating a panorama image containing 360° omni-directional view information, the method comprising decoding a bitstream having data corresponding to a current image and a reference image, generating a motion vector of a current data unit of the current image to correspond to a search area of the reference image which includes a first reference data unit disposed on a first border of the reference image, generating a reference macro block of the first reference data unit of the reference image using a second reference data unit disposed on a second border of the reference image which is not included in the search area according to the motion vector, and generating the current image according to the reference macro block and data corresponding to the decoded bitstream.

The foregoing and/or other aspects of the present general inventive concept may also be achieved by providing a method of estimating a motion vector of a panorama image containing 360° omni-directional view information, the method comprising storing a reference image having first and second borders and first and second reference data units disposed adjacent to the first border and the second border, respectively, within the reference image, receiving a current data unit of a current image and the reference data units of the reference image from the memory, estimating a motion vector of the current data unit using one of the first and second reference data units of the reference image which is not included in a search area when the other one of the first and second reference data units is included in the search area, generating a reference macro block according to the motion vector and the reference image, generating a bitstream according to the current image and the reference macro block, decoding the bitstream having data corresponding to the current image and the reference image, generating the motion vector of the current data unit of the current image to correspond to the search area of the reference image which includes the first reference data unit disposed on the first border of the reference image, generating the reference macro block of the first reference data unit of the reference image using the second reference data unit disposed on the second border of the reference image which is not included in the search area according to the motion vector, and generating the current image according to the reference macro block and data corresponding to the decoded bitstream.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a plurality of previous macro blocks available for conventional estimation of a motion vector for a current macro block;

FIGS. 2A through 2C are diagrams illustrating cases where previous macro blocks to be used for estimation of a motion vector of a current macro block are not present;

FIG. 3 is a diagram illustrating a conventional method of padding a reference image;

FIG. 4A is a diagram illustrating a cylindrical image with a 360° omni-directional view;

FIG. 4B is a diagram illustrating a two-dimensional (2D) image corresponding to the cylindrical image of FIG. 4A;

FIG. 5 is a block diagram illustrating an encoding unit that encodes a motion vector of a panorama image according to an embodiment of the present general inventive concept;

FIGS. 6A and 6B are flowcharts illustrating a method of estimating the motion of a panorama image according to an embodiment of the present general inventive concept;

FIG. 7A is a diagram illustrating selection of previous macro blocks to be used for estimation of a motion vector of a current macro block according to an embodiment of the present general inventive concept;

FIG. 7B is a diagram illustrating selection of previous macro blocks to be used for estimation of a motion vector of a current macro block according to another embodiment of the present general inventive concept;

FIG. 8A is a diagram illustrating a case where a reference macro block partially overlaps with a reference image;

FIG. 8B is a diagram illustrating a case where a reference macro block is positioned outside a reference image;

FIG. 9 is a diagram illustrating a method of padding a reference image according to an embodiment of the present general inventive concept;

FIG. 10 is a diagram illustrating a motion vector of a current macro block;

FIG. 11 is a block diagram illustrating a decoding unit that decodes a motion vector of a panorama image according to an embodiment of the present general inventive concept; and

FIG. 12 is a flowchart illustrating a method of compensating for a motion of a panorama image according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

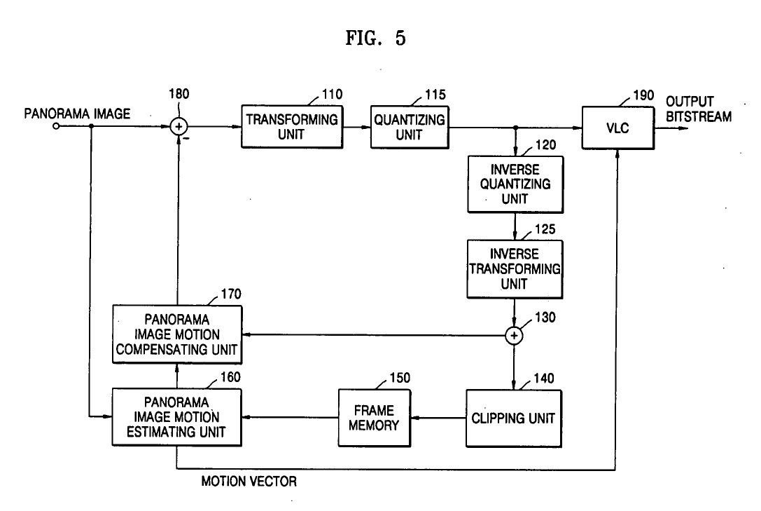

FIG. 5 is a block diagram illustrating an encoding unit that encodes a motion vector of a panorama image according to an embodiment of the present general inventive concept. Referring to FIG. 5, the encoding unit includes a transforming unit 110, a quantizing unit 115, an inverse quantizing unit 120, an inverse transforming unit 125, an adding unit 130, a clipping unit 140, a frame memory 150, a panorama image motion estimation unit 160, a panorama image motion compensation unit 170, a subtraction unit 180, and a variable-length coder (VLC) 190.

The transforming unit 110 receives an input panorama image and transforms the received panorama image through predetermined transformation to output transform coefficients. The input panorama image is a panorama image with a 360° omni-directional view as shown in FIG. 4B, taken along a line X of a cylindrical image shown in FIG. 4A. The predetermined transform performed by the transforming unit 110 may be a discrete cosine transform (DCT) in units of 8×8 blocks.

The quantizing unit 115 quantizes the transform coefficients received from the transforming unit 110. After the quantized transform coefficients are inversely quantized by the inverse quantizing unit 120 and inversely transformed by the inverse transforming unit 125, the input panorama image is reproduced. The reproduced panorama image is normalized by the clipping unit 140 and stored in the frame memory 150. The panorama image stored in the frame memory 150 is used as a reference panorama image in motion estimation and compensation of a newly input panorama image. The adding unit 130 may have a predetermined value, receive the reproduced panorama image, modify the reproduced panorama image using the predetermined value, and output one of the reproduced panorama image and the modified panorama image to the clipping unit 140 and the panorama image motion compensation unit 170 as the reproduced panorama image. It is possible that the modified panorama image is the same as the reproduced panorama image according to the predetermined value.

The panorama image motion estimation unit 160 performs motion estimation, using the reference panorama image stored in the frame memory 150. Specifically, the panorama image motion estimation unit 160 receives information regarding the current panorama image, obtains a motion vector of the current panorama image by performing motion estimation on the current panorama image using the reference panorama image stored in the frame memory 150, and outputs the motion vector to the VLC 190. Motion estimation and compensation are performed in units of predetermined blocks referred to as data units. In this embodiment, the data units may be 16×16 macro blocks.

The panorama image motion compensation unit 170 performs the motion compensation. In detail, the panorama image motion compensation unit 170 receives the motion vector of a current macro block of the current panorama image from the panorama image motion estimation unit 160 and the reference panorama image of the frame memory 150, and outputs a reference macro block corresponding to the current macro block to the subtraction unit 180 using the motion vector of the current macro block of the current panorama image and the reference panorama image of the frame memory 150. The panorama image motion compensation unit 170 may use the reproduced panorama image and the motion vector to generate the reference macro block. The subtraction unit 180 outputs a residual signal between the current macro block and the reference macro block to the transforming unit 110. The residual signal is transformed by the transforming unit 110, quantized by the quantizing unit 115, and variable-length coded by the VLC 190. The motion vector of the current macro block generated by the panorama image motion estimation unit 160 is input directly to and variable-length coded by the VLC 190.

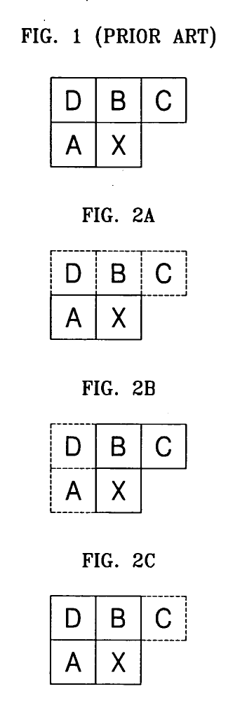

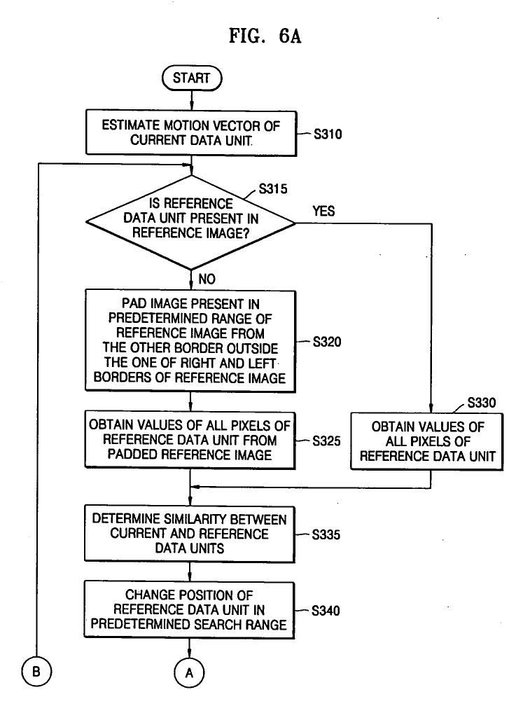

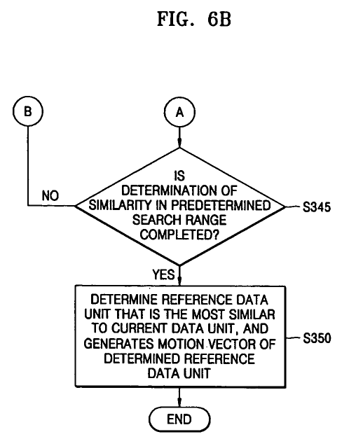

The operation of the panorama image motion estimation unit 160 will now be described in greater detail with reference to FIGS. 6A and 6B. FIGS. 6A and 6B are flowcharts illustrating a method of estimating the motion of a panorama image according to an embodiment of the present general inventive concept. Referring to FIGS. 5, 6A, and 6B, the panorama image motion estimation unit 160 estimates a motion vector of a current data unit using motion vectors of a plurality of previous data units adjacent to the current data unit (S310). As illustrated in FIG. 1, a data unit X is a current data unit, and the data units A, B, C and D are previous data units required for estimation of a motion vector of the current data unit X. In this embodiment, the data units may be 16×16 macro blocks. The current data unit X is included in a current frame, and the plurality of previous data units A, B, C and D are included in a previous frame.

In detail, the panorama image motion estimation unit 160 detects the motion vectors of the previous macro blocks A, B, C, and D stored in an internal memory (not shown). When all the previous macro blocks A through D are present, the motion vector of the current macro block X is estimated according to predetermined or conventional motion estimation, using the detected motion vectors.

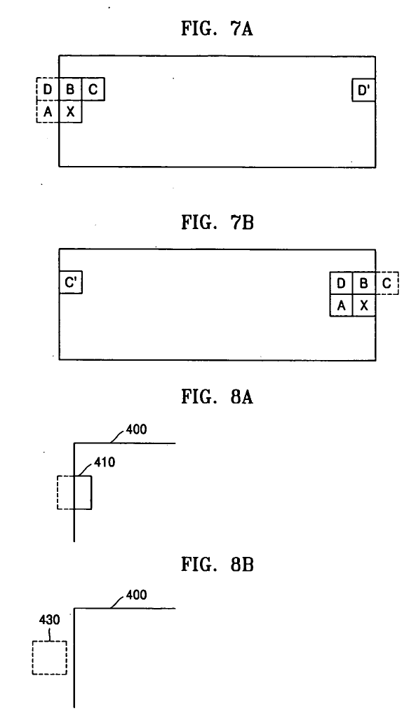

However, at least one of the previous macro blocks A through D may not be present. FIG. 7A illustrates a case where the previous macro blocks A and D are not present in a panorama image, and thus, their motion vectors are unavailable for motion estimation of the current macro block X. FIG. 7B illustrates a case where the previous macro block C is not present in a panorama image, and thus, its motion vector is unavailable for motion estimation of the current macro block×

As described above, a spatial relation between the right and left borders of a panorama image with a 360° omni-directional view is very high. That is, a distance between the right and left borders of the panorama image is substantially 0. According to this embodiment of the present general inventive concept, when one or more of the previous macro blocks A, C, and D required for estimation of the motion vector of the current macro block X are not present, the motion vectors of the previous macro blocks required for motion estimation are determined using the above characteristics of the panorama image. For instance, referring to FIG. 7A, a previous macro block D′ at a right side of the panorama image and on a Y-axis on which the previous macro block D is positioned is substantially the same as the previous macro block D. Accordingly, a motion vector of the previous macro block D′ is considered to be the same as that of the previous macro block D and can be used in estimation of the motion vector of the current macro block X In contrast, when the motion vector of a previous macro block at a right side of the panorama image and on an Y-axis on which the previous macro block A is positioned, is predicted after motion estimation of the current macro block X, there is no available motion vector for the previous macro block A. Accordingly, the motion vector of the previous macro block A required for estimation of the motion vector of the current macro block X is set to 0.

Referring to FIG. 7B, a previous macro block C′ at a left side of the panorama image and on an Y-axis on which the previous macro block C is positioned, is substantially the same as the previous macro block C. Thus, a motion vector of the previous macro block C′ is considered the same as that of the previous macro block C and thus is used in estimation of the motion vector of the current macro block X.

Referring back to FIGS. 6A and 6B, after the motion vector of the current macro block X (or current data unit) is estimated in operation S310, the panorama image motion estimation unit 160 determines whether the reference macro block indicated by the estimated motion vector is present in a reference image (or reference panorama image) in operation S315. The reference image is stored in the frame memory 150.

If all pixels of the reference macro block indicated by the motion vector of the current macro block X are present in the reference image, the pixels of the reference macro block are fetched from the frame memory 150 (S335), and the similarity between the current macro block X and the reference macro block is determined using a predetermined evaluation function (S335).

However, when some or all of the pixels of the reference macro block indicated by the motion vector of the current macro block X are present outside one of right and left borders of the reference image, an image present in a predetermined range of the reference image from the other border is padded outside the one of the right and left borders (S320).

FIG. 8A illustrates a case where the reference macro block is positioned at a border of the reference image. FIG. 8B illustrates a case where the reference macro block is positioned outside the reference image.

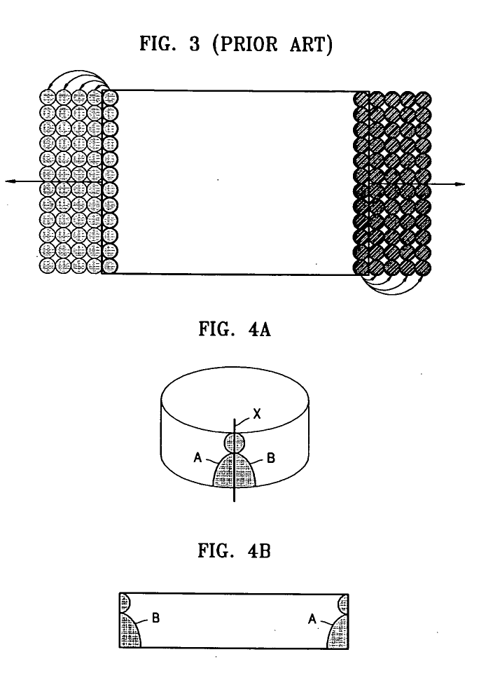

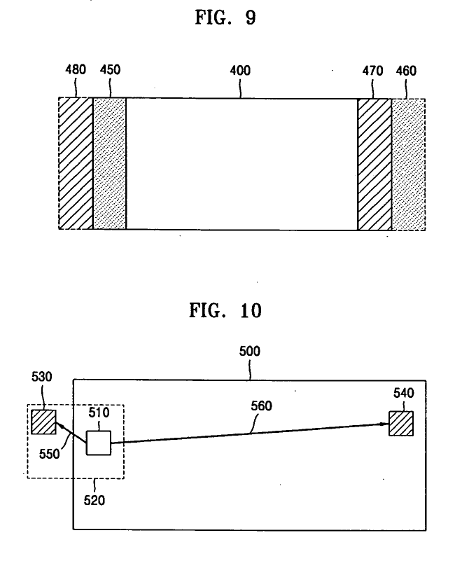

Referring to FIG. 3, conventional motion estimation and compensation are performed after padding values of pixels at a left border of a reference image to the outside of the left border and pixels at a right border of the reference image to the outside of the right border. In contrast, the embodiment of the present general inventive concept is based on that the spatial relation between the right and left borders of a panorama image with a 360° omni-directional view is very high. Referring to FIG. 9, an outside region 480 of a left border region 450 of a reference image 400 is padded with the values of pixels at a right border region 470 of the reference image 400. An outside region 460 of the right border region 470 is padded with the values of pixels at the left border region 450.

Next, after padding the reference image in operation S320, the panorama image motion estimation unit 160 fetches all pixel values of the reference macro block from the padded reference image in the frame memory 150 (S325). Thereafter, the similarity between the current macro block X and the reference macro block is evaluated using a predetermined evaluation function (S335). In general, a sum of absolute differences (SAD) function, a sum of absolute transformed differences (SATD) function, or a sum of squared differences (SSD) function is used as the predetermined evaluation function.

Alternatively, when the reference image is a cylindrical image obtained by connecting the right and left borders of the reference image, it is possible to obtain the values of all pixels of a reference data unit from the cylindrical image without padding the reference image. Specifically, the reference image is a two-dimensional (2D) plane image such as that shown in FIG. 4B, and the cylindrical image such as that shown in FIG. 4A is obtained by connecting the right and left borders of the 2D plane image. That is, when the reference image is a cylindrical image, the values of all pixel values of the reference data unit can be obtained from the cylindrical image.

Next, the panorama image motion estimation unit 160 changes a position of the reference macro block in a predetermined search range and determines the similarity between the changed reference macro block and the current macro block X (S340 and S345). After the evaluation of the similarity between the current macro block X and each of a plurality of reference macro blocks in the predetermined search range, the panorama image motion estimation unit 160 determines a reference macro block that is the most similar to the current macro block Xfrom the plurality of reference macro blocks, and generates a motion vector of the determined reference macro block (S350).

FIG. 10 is a diagram illustrating a motion vector of a current macro block 510. In FIG. 10, a reference numeral 530 denotes the macro block that is most similar to the current macro block 510 and present on the padded reference image, and a reference numeral 540 denotes the macro block that corresponds to the macro block 530 and is present on the non-padded image 500. When the macro block 530 is the most similar to the current macro block 510, a reference numeral 550 denotes the motion vector of the current macro block 510. When the reference macro block 540 is the most similar to the current macro block 510, a reference numeral 560 denotes the motion vector of the current macro block 510. That is, the motion vector of the current macro block 510 may be one of the motion vectors 550 and 560. However, a motion vector of a macro block that does not fall within a predetermined search range may not be transmitted to a decoder (not shown). Therefore, the motion vector 550 of the reference macro block 530 may be determined as the motion vector of the current macro block 510.

A method and apparatus for compensating for the motion of a panorama image according to an embodiment of the present general inventive concept will now be described.

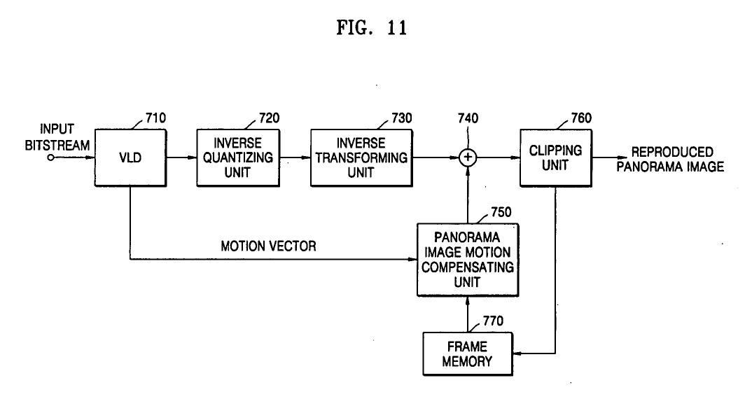

FIG. 11 is a block diagram of a decoding unit that decodes a motion vector of a panorama image according to an embodiment of the present invention. Referring to FIG. 11, the decoder includes a variable-length decoder (VLD) 710, an inverse quantizing unit 720, an inverse transforming unit 730, an adding unit 740, a panorama image motion compensating unit 750, a clipping unit 760, and a frame memory 770.

The VLD 710 decodes an input bitstream using a variable-length coding/decoding method. A motion vector and a residual signal between a macro block and a reference macro block output from the VLD 710 are input to the panorama image motion compensating unit 750 and the inverse quantizing unit 720, respectively.

The frame memory 770 stores a reference panorama image obtained by sequentially inputting the input bitstream to the inverse quantizing unit 720, the inverse transforming unit 730, and the clipping unit 760. The reference panorama image stored in the frame memory 770 is used for compensation for the motion of a newly input panorama image (current panorama image).

The panorama image motion compensating unit 750 performs motion compensation using the reference panorama image stored in the frame memory 770. In detail, the panorama image motion compensating unit 750 receives a motion vector of a current macro block of the panorama image from an encoder such as that shown in FIG. 5, reads a reference macro block of a previous frame corresponding to the current macro block in the frame memory 770, and outputs the read reference macro block to the adding unit 740. Then, the adding unit 740 receives the residual signal between the current macro block and the reference macro block that are inversely quantized by the inverse quantizing unit 720 and inversely transformed by the inverse transforming 730.

The adding unit 740 reproduces the current macro block using the residual signal between the current macro block and the reference macro block, and the reference macro block input from the panorama image motion compensating unit 750. The clipping unit 760 normalizes the reproduced current macro block output from the adding unit 740.

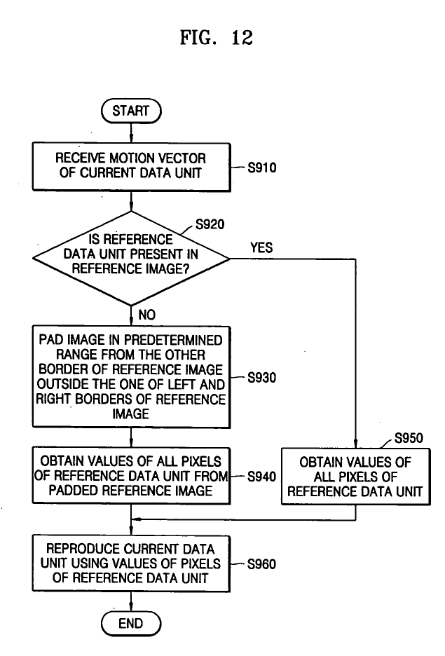

The operation of the panorama image motion compensating unit 750 will now be described in greater detail. FIG. 12 is a flowchart illustrating a method of compensating for the motion of a panorama image according to an embodiment of the present general inventive concept.

Referring to FIGS. 11 and 12, the panorama image motion compensating unit 750 receives a motion vector of a current data unit on which motion estimation is to be performed from the VLD 710 (S910). In this embodiment, data units may be 16×16 macro blocks.

Next, the panorama image motion compensating unit 750 determines whether a reference macro block indicated by the motion vector of the current macro block is present in a reference image (S920). The reference image is stored in the frame memory 770.

When pixels of the reference macro block indicated by the motion vector of the current macro block are present in the reference image, the values of all pixels of the reference macro block are read from the frame memory 770 (S950), and the current macro block is reproduced (S960). The adding unit 740 reproduces the current macro block, using the residual signal between the current macro block and the reference macro block output from the inversely transforming unit 730 and the reference macro block output from the panorama image motion compensating unit 750.

However, as illustrated in FIG. 8A or 8B, when some or all of the pixels of the reference macro block indicated by the motion vector of the current macro block are positioned outside one of left and right borders of the reference image, an image in a predetermined range from the other border of the reference image is padded outside the one of the left and right borders (S930). According to the present invention, as illustrated in FIG. 9, regions outside of the reference image are padded based on that the spatial relation between right and left borders of a panorama image with a 360° omni-directional view is very high.

Next, after padding the reference image in operation S930, the panorama image motion compensating unit 750 reads the values of all pixels of the reference macro block from the padded reference image from the frame memory 770 (S940).

Alternatively, when the reference image is a cylindrical image obtained by connecting the left and right borders of the reference image, it is possible to obtain the values of all pixels of the reference data unit from the cylindrical image without padding the reference image. More specifically, the reference image is a 2D plane image such as that shown in FIG. 4B, and the cylindrical image such as that shown in FIG. 4B is obtained by connecting the left and right borders of the 2D plane image. That is, if the reference image is the cylindrical image, the values of all pixels of the reference data unit can be obtained from the cylindrical image.

Lastly, the adding unit 740 reproduces the current macro block using the residual signal between the current macro block and the reference macro block and the reference macro block input from the panorama image motion compensating unit 750 (S960).

The present general inventive concept may be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system.

As described above, according to the present general inventive concept, motion estimation and compensation are performed on a panorama image with a 360° omni-directional view based on that the spatial relation between right and left borders of the panorama image is very high, thereby increasing the efficiency and precision of motion estimation and compensation. Accordingly, it is possible to improve image quality, in particular, the image quality at the right and left borders of the panorama image.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of estimating a motion of a panorama image containing 360° omni-directional view information, the method comprising:
estimating a motion vector of a current data unit of the panorama image using motion vectors of a plurality of previous reference data units adjacent to the current data unit;
when one or more pixels of one of the reference data units indicated by the estimated motion vector are present outside one of left and right borders of the reference image, padding the reference image in a predetermined range from the other border of the reference image outside the one of the left and right borders;
obtaining values of all pixels of the one of the reference data units from the padded reference image; and
determining a similarity between the current data unit and the reference data unit using a predetermined evaluation function.

2. The method of claim 1, wherein when the one or more of the plurality of the previous data units is present outside one of the left and right borders of the panorama image, the estimating of the motion vector of the current data unit comprises:
determining the plurality of the previous data units from a cylindrical image which is obtained by connecting the left and right borders of the reference image when the reference image is the cylindrical image.

3. The method of claim 1, wherein the plurality of the previous data units comprise:
a first data unit disposed adjacent to a position corresponding to a left side of the current data unit;
a second data unit disposed adjacent to a position corresponding to a top of the current data unit;
a third data unit disposed adjacent to a right side of the second data unit; and
a fourth data unit disposed adjacent to both the first and second data units.

4. The method of claim 1, further comprising:
determining the one of the reference data units which is the most similar to the current data unit in a predetermined search range; and
determining the motion vector representing the determined reference data unit.

5. A method of estimating a motion of a panorama image containing 360° omni-directional view information, the method comprising:
estimating a motion vector of a current data unit of the panorama image, using motion vectors of a plurality of previous reference data units adjacent to the current data unit;
when one or more pixels of one of the reference data units indicated by the estimated motion vector are present outside one of left and right borders of the reference image, obtaining values of all pixels of one of the reference data units of the reference image from a cylindrical image which is obtained by connecting the left and right borders of the reference image when the reference image is the cylindrical image; and
determining a similarity between the current data unit and the reference data unit using a predetermined evaluation function.

6. The method of claim 5, wherein when at least one of the plurality of the previous reference data units is present outside one of the left and right borders of the panorama image, the estimating of the motion vector of the current data unit comprises:
determining the plurality of the previous reference data units from a cylindrical image which is obtained by connecting the left and right borders of the reference image on when the panorama image is the cylindrical image.

7. The method of claim 5, wherein the plurality of the previous data units comprise:
a first data unit disposed adjacent to a position corresponding to a left side of the current data unit;
a second data unit disposed adjacent to a position corresponding to a top of the current data unit;
a third data unit disposed adjacent to a right side of the second data unit; and
a fourth data unit disposed adjacent to both the first and second data units.

8. The method of claim 5, further comprising:
determining the one of the reference data units which is the most similar to the current data unit in a predetermined search range; and
determining the motion vector representation of the determined reference data unit.

9. An apparatus to compensate for a motion of a panorama image containing 360° omni-directional view information, the apparatus comprising:
a memory to store a reference image to be used for motion estimation of a panorama image, and motion vectors of a plurality of previous reference data units adjacent to a current data unit of the panorama image; and
a motion estimating unit to estimate a motion vector of the current data unit using the motion vectors of the plurality of the reference data units, when one or more pixels of one of the reference data units indicated by the estimated motion vector are present outside one of left and right borders of the reference image, to pad the reference image in a predetermined range from the other border of the reference image outside the one of the left and right borders, to obtain values of all pixels of the reference data unit from the padded reference image, and to determine a similarity between the current data unit and the reference data unit using a predetermined evaluation function.

10. The apparatus of claim 9, wherein when the one of the plurality of the reference data units is present outside one of the left and right borders of the panorama image, the motion estimating unit determines the plurality of the reference data units from a cylindrical image which is obtained by connecting the left and right borders of the panorama image when the panorama image is the cylindrical image.

11. The apparatus of claim 9, wherein the plurality of the reference data units comprise:
a first data unit disposed adjacent to a position corresponding to a left side of the current data unit;
a second data unit disposed adjacent to a position corresponding to a top of the current data unit;
a third data unit disposed adjacent to a right side to the second data unit; and
a fourth data unit disposed adjacent to both the first and second data units.

12. The apparatus of claim 9, wherein the motion estimating unit determines the one of the reference data units which is the most similar to the current data unit in a predetermined search range, and determines the motion vector representing the determined reference data unit.

13. An apparatus for estimating a motion of a panorama image containing 360° omni-directional view information, the apparatus comprising:
a memory to store a reference image to be used for motion estimation of a panorama image, and motion vectors of a plurality of previous reference data units adjacent to a current data unit of the panorama image; and
a motion estimating unit to estimate a motion vector of the current data unit using the motion vectors of the plurality of the reference data units, when one or more pixels of the one of the reference data units indicated by the estimated motion vector are present outside one of left and right borders of the reference image, to obtain values of all pixels of the one of the reference data units from a cylindrical image obtained by connecting the left and right borders of the reference image when the reference image is the cylindrical image, and to determine a similarity between the current data unit and the reference data unit using a predetermined evaluation function.

14. The apparatus of claim 13, wherein when the one of the plurality of the reference data units is present outside one of the left and right borders of the panorama image, the motion estimating unit determines the plurality of the reference data units from a cylindrical image obtained by connecting the left and right borders of the panorama image when the panorama image is the cylindrical image.

15. The apparatus of claim 13, wherein the plurality of the reference data units comprise:
a first data unit disposed adjacent to a position corresponding to a left side of the current data unit;
a second data unit disposed adjacent to a position corresponding to a top of the current data unit;
a third data unit disposed adjacent to a right side of the second data unit; and
a fourth data unit disposed adjacent to both the first and second data units.

16. The apparatus of claim 13, wherein the motion estimating unit determines one of the reference data units which is the most similar to the current data unit in a predetermined search range, and determines the motion vector representing the determined reference data unit.

17. A method of compensating for a motion of a panorama image containing 360° omni-directional view information, the method comprising:
receiving a motion vector of a current data unit of a panorama image;
when one or more pixels of one of reference data units of a panorama reference image indicated by the motion vector of the current data unit are present outside one of left and right borders of the reference image, padding an image in a predetermined range from the other border of the reference image outside the one of the left and right borders of the reference image;
obtaining values of all pixels of the reference data unit from the padded reference image; and
reproducing the current data unit using the values of the pixels of the reference data unit.

18. A method of compensating for a motion of a panorama image containing 360° omni-directional view information, the method comprising:
receiving a motion vector of a current data unit of the panorama image;
when one or more pixels of a reference data unit of a reference image indicated by the motion vector of the current data unit are present outside one of left and right borders of the reference image, obtaining values of all pixels of the one of the reference data units from a cylindrical image which is obtained by connecting the left and right borders of the reference image when the reference image is the cylindrical image; and
reproducing the current data unit using the values of the pixels of the one of the reference data units.

19. An apparatus to compensate for a motion of a panorama image containing 360° omni-directional view information, the apparatus comprising:
a memory to store a reference image to be used for motion estimation of a panorama image; and
a motion compensating unit to recover a motion vector of a current data unit of the panorama image, when one or more pixels of one of reference data units of the reference image indicated by the motion vector of the current data unit are present outside one of left and right borders of the reference image, to pad the reference image in a predetermined range from the other border of the reference image outside the one of the left and right borders of the reference image, to obtain values of all pixels of the one of the reference data units from the padded reference image, and to reproduce the current data unit using the values of the pixels of the reference data unit.

20. An apparatus to compensate for the motion of a panorama image containing 360° omni-directional view information, the apparatus comprising:
a memory to store a reference image to be used for motion estimation of a current panorama image; and
a motion compensating unit to receive a motion vector of a current data unit of the panorama image, when one or more pixels of one of reference data units of the reference image indicated by the motion vector of the current data unit are present outside one of left and right borders of the reference image, to obtain values of all pixels of the one of the reference data units from a cylindrical image which is obtained by connecting the left and rights borders of the reference image when the reference image is the cylindrical image, and to reproduce the current data unit using the values of the pixels of the reference data unit.

21. A computer readable medium having embodied thereon a program for executing a method of estimating a motion vector of a panorama image containing 360° omni-directional view information, the method comprising:
estimating a motion vector of a current data unit of a current panorama image using motion vectors of a plurality of previous reference data units adjacent to the current data unit;
when one or more pixels of one of reference data units of a reference panorama image indicated by the estimated motion vector are present outside one of left and right borders of a reference image, padding the reference image in a predetermined range from the other border of the reference image outside the one of the left and right borders;
obtaining values of all pixels of the one of the reference data units from the padded reference image; and
determining a similarity between the current data unit and the reference data unit using a predetermined evaluation function.

22. A computer readable medium having embodied thereon a program for executing a method of estimating the motion of a panorama image containing 360° omni-directional view information, the method comprising:
estimating a motion vector of a current data unit of a current panorama image using motion vectors of a plurality of previous reference data units adjacent to the current data unit;
when one or more pixels of one of reference data units of a reference image indicated by the estimated motion vector are present outside one of left and right borders of the reference image, obtaining values of all pixels of the reference image from a cylindrical image which is obtained by connecting the left and right borders of the reference image when the reference image is the cylindrical image; and
determining a similarity between the current data unit and the reference data unit using a predetermined evaluation function.

23. A computer readable medium having embodied thereon a program for executing a method of compensating for a motion of a panorama image containing 360° omni-directional view information, the method comprising:
receiving a motion vector of a current data unit of a current panorama image;
when one or more pixels of one of reference data units of a reference image indicated by the motion vector of the current data unit are present outside one of left and right borders of the reference image, padding the reference image in a predetermined range from the other border of the reference image outside the one of the left and right borders of the reference image;
obtaining values of all pixels of the reference data unit from the padded reference image; and
reproducing the current data unit using the values of the pixels of the reference data unit.

24. A computer readable medium having embodied thereon a program for executing a method of compensating for a motion of a panorama image containing 360° omni-directional view information, the method comprising:
receiving a motion vector of a current data unit of a panorama image;
when one or more pixels of one of reference data units of a reference image indicated by the motion vector of the current data unit are present outside one of left and right borders of the reference image, obtaining values of all pixels of the reference data unit from a cylindrical image which is obtained by connecting the left and right borders of the reference image when the reference image is the cylindrical image; and
reproducing the current data unit using the values of the pixels of the reference data unit.

25. An apparatus to estimate a motion vector of a panorama image containing 360° omni-directional view information, the apparatus comprising:
a memory to store a reference image having first and second borders and first and second reference data units disposed adjacent to the first border and the second border, respectively, within the reference image; and
a motion estimating unit to receive a current data unit of a current image and the reference data units of the reference image from the memory, and to estimate a motion vector of the current data unit using one of the first and second reference data units of the reference image which is not included in a search area when the other one of the first and second reference data units is included in the search area.

26. The apparatus of claim 25, wherein the reference image comprises a cylindrical image formed when the first and second borders are connected, and the first and second reference data units comprise first and second macro blocks, respectively, having a spatial relationship therebetween and disposed adjacent to each other in the cylindrical image.

27. The apparatus of claim 25, wherein the reference image and the current image comprise panorama images, and the searching area includes one of the first and second reference data units disposed in an outside of a searching area of the motion vector of the current data unit while the other one of the first and second reference data units is disposed within the searching area.

28. The apparatus of claim 25, further comprising:
a panorama image motion compensating unit to generate a reference macro block according to the motion vector and the reference image; and
an encoding unit to generate a signal corresponding to the reference image according to the reference macro block and the current image.

29. The apparatus of claim 28, further comprising:
a second unit to generate the motion vector according to a coded signal corresponding to the quantized transform coefficients, and to generate a residual signal according to the coded signal;
a second panorama image motion compensating unit to generate the reference macro block according to the motion vector; and
a third unit to generate the current image according to the reference macro block and the residual signal.

30. An apparatus to generate a panorama image containing 360° omni-directional view information, the apparatus comprising:
a decoding unit to decode a bitstream having data corresponding to a current image and a reference image, and to generate a motion vector of a current data unit of the current image to correspond to a search area of the reference image which includes a first reference data unit disposed on a first border of the reference image;
a panorama image motion compensating unit to generate a reference macro block of the first reference data unit of the reference image using a second reference data unit disposed on a second border of the reference image which is not included in the search area according to the motion vector; and
an output unit to generate the current image according to the reference macro block and data corresponding to the decoded bitstream.

31. An apparatus to estimate a motion vector of a panorama image containing 360° omni-directional view information, the apparatus comprising:
an encoder comprising:
a memory to store a reference image having first and second borders and first and second reference data units disposed adjacent to the first border and the second border, respectively, within the reference image,
a motion estimating unit to receive a current data unit of a current image and the reference data units of the reference image from the memory, and to estimate a motion vector of the current data unit using one of the first and second reference data units of the reference image which is not included in a search area when the other one of the first and second reference data units is included in the search area,
a panorama image motion compensating unit to generate a reference macro block according to the motion vector and the reference image, and
a coding unit to generate an bitstream according to the current image and the reference macro block; and
a decoder comprising:
a decoding unit to decode the bitstream having data corresponding to the current image and the reference image, and to generate the motion vector of the current data unit of the current image to correspond to the search area of the reference image which includes the first reference data unit disposed on the first border of the reference image,
a second panorama image motion compensating unit to generate the reference macro block of the first reference data unit of the reference image using the second reference data unit disposed on the second border of the reference image which is not included in the search area according to the motion vector, and
an output unit to generate the current image according to the reference macro block and data corresponding to the decoded bitstream.

32. A method of estimating a motion vector of a panorama image containing 360° omni-directional view information, the method comprising:
storing a reference image having first and second borders and first and second reference data units disposed adjacent to the first border and the second border, respectively, within the reference image; and
receiving a current data unit of a current image and the reference data units of the reference image from the memory, and estimating a motion vector of the current data unit using one of the first and second reference data units of the reference image which is not included in a search area when the other one of the first and second reference data units is included in the search area.

33. The method of claim 32, further comprising:
generating a reference macro block according to the motion vector and the reference image; and
generating the reference image according to the reference macro block and the current image.

34. A method of generating a panorama image containing 360° omni-directional view information, the method comprising:
decoding a bitstream having data corresponding to a current image and a reference image, and generating a motion vector of a current data unit of the current image to correspond to a search area of the reference image which includes a first reference data unit disposed on a first border of the reference image;
generating a reference macro block of the first reference data unit of the reference image using a second reference data unit disposed on a second border of the reference image which is not included in the search area according to the motion vector; and
generating the current image according to the reference macro block and data corresponding to the decoded bitstream.

35. A method of estimating a motion vector of a panorama image containing 360° omni-directional view information, the method comprising:
storing a reference image having first and second borders and first and second reference data units disposed adjacent to the first border and the second border, respectively, within the reference image;
receiving a current data unit of a current image and the reference data units of the reference image from the memory, and estimating a motion vector of the current data unit using one of the first and second reference data units of the reference image which is not included in a search area when the other one of the first and second reference data units is included in the search area;
generating a reference macro block according to the motion vector and the reference image;
generating a bitstream according to the current image and the reference macro block;
decoding the bitstream having data corresponding to the current image and the reference image, and generating the motion vector of the current data unit of the current image to correspond to the search area of the reference image which includes the first reference data unit disposed on the first border of the reference image;
generating the reference macro block of the first reference data unit of the reference image using the second reference data unit disposed on the second border of the reference image which is not included in the search area according to the motion vector, and
generating the current image according to the reference macro block and data corresponding to the decoded bitstream.
